(19) United States
(12) Patent Application Publication
(10) Pub. No.: US 2010/0163577 A1
(43) Pub. Date: Jul. 1, 2010

(54) CONTAINER, PARTICULARLY A HERMETICALLY SEALED AMPOULE

(76) Inventor: Bernd Hansen, Sulzbach-Laufen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/449,610

(22) PCT Filed: Dec. 8, 2007
(86) PCT No.: PCT/EP2007/010707

§ 371 Date: Dec. 16, 2009

(30) Foreign Application Priority Data
Feb. 27, 2007 (DE) 10 2007 009 457.6

(51) Int. Cl. B67D 7/74; B65D 47/10

(52) U.S. Cl. 222/129; 222/541.9

(57) ABSTRACT

A container, particularly a hermetically sealed ampoule, having a hollow receiving body (1) for receiving a discharge medium, comprising it discharge opening (3), which is scaled by a sealing part (9) formed by a head part of the container, the scaling part being separable from the edge of the discharge opening (3) via a separation point (11), and comprising a handling aid connected to the end (15) removed from the discharge opening (3) in the form of a connecting tab (19), is characterized in that a second handling aid (25) connected to the sealing part (9) is provided, which, like the first handling aid, is formed by a second connecting tab (25).

The invention relates to a container, particularly a hermetically sealed ampule, with a hollow receiving body for receiving a discharge medium, which has a discharge opening that is closed by a sealing part that forms the head part of the container and which can be separated from the edge of the discharge opening by way of a separation point, and with a handling aid which is connected to the end away from the discharge opening in the form of a connecting tab.

Containers of this type are used, in particular, to store discharge media of the most varied type in the hollow receiving body, preferably in the form of medical solutions, suspensions or gels. In order to be able to clear the discharge opening of the receiving body for discharge of the medium, there is a sealing part which forms the head part of the container and which can be separated from the remaining receiving body by way of a predetermined separation point in a so-called twist-off movement as a twist closure part.

In order to facilitate handling of these or similar containers, it is also already prior art, compare DE 10 2004 046 536 A1, to provide a connecting tab which is molded onto the end away from the discharge opening and which makes available a gripping surface which, especially for small-volume ampules, facilitates their handling, for example for carrying out a discharge process.

In spite of the additional gripping surface which is formed by the connecting tab and which facilitates and simplifies handling in removal processes, for small-volume containers with correspondingly small head parts, separation of the sealing part for clearing the discharge opening is made difficult and tedious. The object of the invention is therefore to make available a container of the indicated type which can be handled especially easily and comfortably, in particular also with respect to the process of opening the discharge opening.

According to the invention this object is achieved by a container which has the features of claim 1 in its entirety.

Accordingly, the invention is characterized in that on the two opposite ends there are connecting tabs which form handling aids, of which the first is molded on the end away from the discharge opening, while the second connecting tab is connected to the sealing part. In this way this connecting tab forms a widening of the surface of the sealing part with the corresponding enlargement of the gripping surface which is available for twisting off the sealing part so that the sealing part can be separated easily from the edge of the discharge opening at the separation point.

Preferably the two connecting tabs are formed by plate-like bodies.

In especially advantageous embodiments the two connecting tabs are more or less rectangular in outline, the longitudinal sides of the rectangular shape running parallel to the longitudinal axis. This elongated tabular shape offers not only a gripping surface which is well-suited for handling, but is also especially well-suited as a vehicle for visually detectable markings or coding that is provided on at least one wide side.

As a result of the straight side edges of the connecting tabs which run in the longitudinal direction, several containers, especially when the side edges of the first connecting tab and the second connecting tab are aligned with one another in the longitudinal direction, can be advantageously combined into a block of ampules in which the containers along the side edges of their connecting tabs are separably joined to one another.

In especially advantageous embodiments the sealing part has a body that forms a hollow chamber which keeps the discharge opening clear. With its lower enclosing edge this hollow chamber ensures that both during the molding process for the container and also later, when the head part is separated, the discharge opening it not unintentionally closed.

In advantageous embodiments in which the sealing part has a sealing ball which contains a hollow chamber and which is detachably connected to the edge of the discharge opening by way of the separation point, the spherical shape ensures that the plastic material used to produce the container in the molding tool can be drawn over a type of edge in order in this way to reduce the plastic material for forming the separation point.

Preferably, the arrangement is made such that the discharge opening is connected from the receiving body by way of a connecting body which forms the neck part of the container and which contains a connecting channel. This three-dimensional separation of the discharge opening from the receiving body is especially advantageous when high-precision application of droplets of the container contents is intended because the connecting body that forms the neck part can assume the shape of an elongated dropper, from whose discharge opening discharge in droplet form can take place, for example, by pressing on the receiving body which is located at a distance from the application point.

In especially advantageous embodiments the arrangement is made such that the connecting body and preferably also the connecting channel taper conically from the receiving body to the discharge opening. For the connecting body this yields not only the desired shape of an elongated dropper with a relatively small outside diameter on the discharge end, but also only a relatively low “secondary volume” is formed for the discharge medium which is located outside the receiving body.

In especially advantageous embodiments the second connecting tab assigned to the sealing part has a shoulder that forms two diametrically opposite flanks which extend on both sides beyond the sealing ball into the initial region of the connecting body and, being used as reinforcing elements in the region of the separation point, the separation point continues into the initial region of the connecting body. The danger of unintentional opening of the discharge opening by random loads acting on the comparatively large-area connecting tab is thus effectively avoided.

The invention is detailed below using one embodiment shown in the drawings.

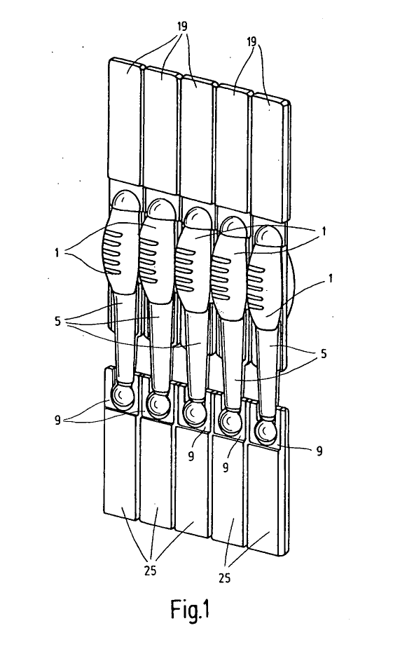

FIG. 1 shows a perspective oblique view of a block of ampules with five containers as claimed in the invention according to the embodiment to be described here, shown without coding or lettering;

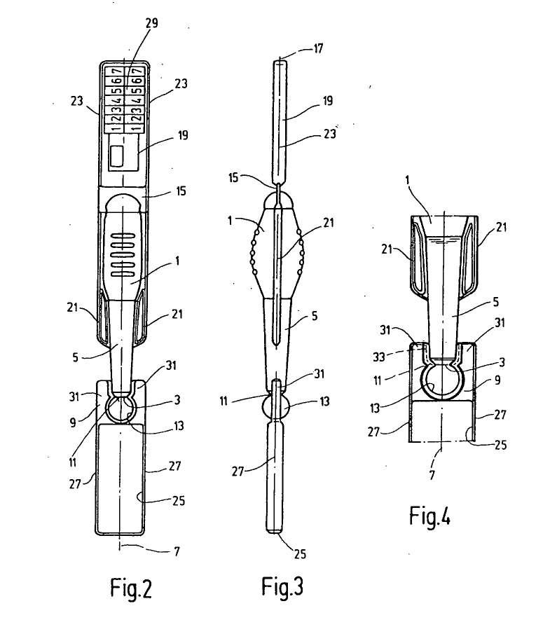

FIG. 2 shows a front view of an individual container of the block of ampules, provided with lettering;

FIG. 3 shows a side view from FIG. 2 and

FIG. 4 shows a detached partial front view of the embodiment which is shown greatly enlarged relative to FIG. 2.

The container according to the invention is designed particularly in the form of a hermetically sealed ampule. A combination of five of these containers is shown in FIG. 1, the individual containers being separable along their respectively adjoining longitudinal edge from one another with the formation of individual containers. Almost any rows can be produced on the container which is to be manufactured, and also individual containers.

The indicated containers are produced from a moldable plastic material, for example of polyamide or polyolefins, such as PE or PP material. Furthermore, it is possible to produce these container products in a co-extrusion process with a multilayer wall structure, or to provide the plastic with a coating in order to increase its impermeability, for example to vapor-coat the container on the outside. Preferably, in any case materials are used which can be easily used for a blow molding, filling and sealing process, as has become known, for example, in the trade under the trade name “bottelpack®.”

Each container has a hollow, blow-molded receiving body 1 which is used to hold a discharge medium that is not detailed, including in the form of medical liquids, suspensions, gels and the like which are added sterile. Between the actual receiving body 1 and the discharge opening 3 which is shown in particular in FIGS. 2 and 4, a connecting body 5 extends which forms a neck part of the container and which tapers conically from the receiving body 1 to the discharge opening 3. A connecting channel which is not visible in the drawings and which extends in the connecting body in the direction of the longitudinal axis 7 to the discharge opening 3 likewise tapers in the direction to the discharge opening 3 so that the connecting body 5 when the discharge opening 3 has been opened forms a type of dropper element for discharge of the medium in droplet form.

The neck part of the container formed by the connecting body 5 is connected to a sealing part 9 which forms the head part and which is detachably connected to the connecting body 5 in the region of the discharge opening 3 by way of a separation point 11 which is used as a predetermined breaking point. This separation point 11 can be formed by a plastic wall part which is reduced in wall thickness and which extends between the sealing part 9 and the connecting body 5. This separation point 11 is made such that the sealing part 9 can be twisted off the connecting body in the manner of a twist closure (twist-off closure) in order in this way to clear the discharge opening 3. The sealing part 9 as the actual sealing body has a sealing ball 13 that forms an inner hollow chamber into which the discharge opening 3 empties. The spherical shape ensures that the plastic material used can be drawn over a type of edge in the molding tool in order in this way to reduce the plastic material for forming the separation point 11.

The bottom-side end 15 opposite the neck part (connecting body 5), where the container wall adjoins the mold separating plane 17 (FIG. 3) to form the bottom-side closure of the receiving container 1, conventionally is adjoined by a bottom-side connecting tab 19 which is made in the form of a plate-shaped body with a more or less elongated rectangular shape, the plate thickness being greater than the wall thickness on the bottom-side end 15 so that the wide sides of the connecting tab 19 lie laterally outside the separating plane 17. As FIGS. 2 and 3 show, one lateral reinforcing strip 21 at a time, aligned with the axially parallel side edges 23 of the connecting tab 19, extends from the region of the bottom-side end 15 to approximately one half of the axial length of the connecting body 5 on both sides.

In the container according to the invention the sealing part 9 is adjoined by a second connecting tab 25 which is similar to the first connecting tab 19 and which, see especially FIG. 3, likewise has a material thickness which has been increased relative to the adjacent region and is made more or less as a rectangular plate whose side edges 27 are aligned with the side edges 23 of the first connecting tab 19 and the edges of the strips 21. In the illustrated example (FIG. 2) one of the wide sides of the first connecting tab 19 is provided with code marking 29. It goes without saying that the second connecting tab 25 could also be provided with the corresponding marking or lettering.

As is apparent from the FIGS., the sealing part 9, viewed from the second connecting tab 25, forms a shoulder or continuation thereof that forms two diametrically opposite flanks 31 which extend beyond the region of the discharge opening 3 into the initial region of the connecting body 5, with which they are connected by way of the continuation region 23 (FIG. 4) of the separation point 11. The flanks 31 whose material thickness corresponds roughly to that of the reinforcing strips 21 form a sealing reinforcement against unintentional clearance of the discharge opening 3. Due to the presence of the second connecting tab 25 this gain of safety, however, need not be achieved at the cost of a reduction of the ease of operation because the presence of a second connecting tab 25 makes available a handling aid which easily enables easy, intentional opening in spite of the improved strength of the sealing region.

1. A container, particularly a hermetically sealed ampule, with a hollow receiving body (1) for receiving a discharge medium, which has a discharge opening (3) that is closed by a sealing part (9) which forms the head part of the container and which can be separated from the edge of the discharge opening (3) by way of the separation point (11), and with a handling aid which is connected to the end (15) away from the discharge opening (3) in the form of a connecting tab (19), characterized in that there is a second handling aid (25) which adjoins the sealing part (9) and which is formed by a second connecting tab (25), like the first handling aid.

2. The container according to claim 1, characterized in that the two connecting tabs (19, 25) are formed by plate-shaped bodies.

3. The container according to claim 1, characterized in that the two connecting tabs (19, 25) are more or less rectangular in outline, the longitudinal sides of the rectangular shape running parallel to the longitudinal axis (7).

4. The container according to claim 2, characterized in that at least one (19) of the connecting tabs (19, 25) is provided on at least one wide side as a vehicle for visually detectable markings (29).

5. The container according to claim 1, characterized in that the sealing part (9) has a body (13) that forms a hollow chamber which keeps the discharge opening (3) clear.

6. The container according to claim 5, characterized in that the sealing part (9) has a sealing ball (13) which contains a hollow chamber and which is detachably connected to the edge of the discharge opening (3) by way of the separation point (11).

7. The container according to claim 1, characterized in that the discharge opening (3) is connected from the receiving body (1) by way of a connecting body (5) which contains a connecting channel that forms the neck part of the container.

8. The container according to claim 7, characterized in that the connecting body (5) and preferably also the connecting channel taper conically from the receiving body (1) to the discharge opening (3).

9. The container according to claim 7, characterized in that the second connecting tab (25) assigned to the sealing part (9) has a shoulder that forms two diametrically opposite flanks (31) which extend on both sides beyond the sealing ball (13) into the initial region of the connecting body (5) and, being used as reinforcing elements in the region of the separation point, the separating point (11, 33) continues into the initial region of the connecting body (5).

10. The container according to claims 1, characterized in that several containers are combined into a block of ampules and along the side edges (23, 27) of their connecting tabs (19, 25) are separably joined to one another.
